(19) United States
(12) Patent Application Publication
(10) Pub. No.: US 2010/0230195 A1
(43) Pub. Date: Sep. 16, 2010

(54) Arrangement of a Radiator and a Shock Absorber and Beam in a Motor Vehicle

(75) Inventors: Stéphane Ginja, Amberieu en Bugey (FR); Philippe Gilotte, Benonces (FR)

Correspondence Address: Osler, Hoskin & Harcourt LLP (Cabinet LLR), 1000 de La Gauchetiere Street West, Suite 2100, Montreal, QC, H3B 4W5, CA

(73) Assignee: COMPAGNIE PLASTIC OMNIUM, Lyon (FR)

(21) Appl. No.: 12/299,848

(22) PCT Filed: May 16, 2007
(86) PCT No.: PCT/FR2007/051291

§ 371 Date: Jul. 7, 2009

(30) Foreign Application Priority Data
May 19, 2006 (FR) 0604511

(51) Int. Cl. B60K 11/04; B60R 21/34; B62D 25/08

(52) U.S. Cl. 180/68.1; 296/187.04

(57) ABSTRACT

The invention relates to an arrangement of a radiator (10), an absorber (12), and an impact beam (18) on a motor vehicle, the beam having a front face (19). The absorber comprises a top transverse element (14) and two vertical legs (16), the transverse element and the legs are arranged in such a manner as to guide air entering the vehicle from the front substantially towards the entire surface area of the radiator, and the top transverse element is mounted on the front face of the beam.

### TECHNICAL FIELD

The present invention relates to an arrangement of a radiator, an absorber, and an impact beam on a motor vehicle.

### STATE OF THE ART

In a motor vehicle, it is known that a radiator is generally positioned in the front unit, set back from the front ends of the side rails and behind the rigid impact beam so as to be protected in the event of an impact. The radiator extends vertically above and below the impact beam.

On traditional vehicles, absorbers known as “crash boxes” are provided between the ends of the side rails and the impact beam, so the radiator is set back a certain distance from the beam as a result of the depth of the crash boxes. A space is thus created between the radiator and the impact beam, such that the impact beam does not present too great an obstacle for air entering via an inlet opening provided at the front of the vehicle and then flowing towards the entire surface area of the radiator, even if the air inlet opening is smaller than the surface area of the radiator. Thus, the air passes round the impact beam and can be fed to the entire surface area of the radiator, in particular its surface areas facing the impact beam, and where appropriate, at a height that is different from the height of the air inlet opening.

### PROBLEM POSED BY THAT STATE OF THE ART

It appears to be advantageous to mount the beam directly on the side rails, this would provide a better distribution of the forces received by the rigid beam between the side rails.

However, under such circumstances, two problems arise.

Firstly there would be very little space between the impact beam and the radiator, such that air entering the vehicle from the front would not have enough room to go round the impact beam and feed surface areas of the radiator that are not directly in register with the air inlet opening. Thus, such a configuration would impede good cooling of the radiator, since only a fraction thereof would be fed with air.

Furthermore, the function provided by the crash boxes would not be performed and the energy of an impact would be transmitted directly to the structure of the vehicle.

### SOLUTION PROPOSED BY THE INVENTION

The invention seeks to provide an arrangement that makes the above-proposed configuration possible while nevertheless ensuring a good supply of air to the surface area of the radiator and good absorption of impacts.

To this end, the invention provides an arrangement of a radiator, an absorber, and an impact beam on a motor vehicle, the beam having a front face, and the arrangement being characterized in that the absorber comprises a top transverse element and two vertical legs, in that the transverse element and the legs are arranged in such a manner as to guide air entering the vehicle from the front substantially towards the entire surface area of the radiator, and in that the top transverse element is mounted on the front face of the beam.

Below, the term “impact beam” is used to designate a rigid structure extending between two points to which it is fastened. The term “absorber” is used to designate any energy absorption means or set of means capable of consuming energy by deforming, such as a honeycomb. The top transverse element and each of the vertical legs comprise absorption means. Finally, the term “substantially the entire surface area of the radiator” is used to mean that at least 90% of the surface area of the radiator lies in the stream defined by the absorber.

By means of the invention, the absorber arranged upstream from the radiator defines a compartment for guiding air between the bumper skin and the radiator. Since the top portion of the compartment is made up of the transverse element mounted on the beam, the beam does not impede cooling of the radiator, since the entire surface area thereof is fed with air because it constitutes the end wall of the guide compartment.

In addition, such an arrangement provide good impact absorption because the absorber is mounted in front of the beam, while also allowing the beam to be mounted directly on the side rails. By virtue of this configuration, in the event of an insurance type impact (also referred to as a repairable, Danner, or AZT impact), the beam does not suffer permanent deformation, thereby co-operating with the side walls to create a safety cell within which parts are not subjected to impacts. Thus, a greater number of parts, such as the radiator and the fans, are protected and do not need to be replaced.

Among the advantages of the invention, it can be observed that the number of parts constituting the front unit is reduced. There is no longer any need to provide any specific converging portions for air sealing since their function is performed by the absorber. Furthermore, assembly is made simpler: managing closure clearances between the bumper skin and the radiator is made easier, and the cooling and absorption modules of the vehicle can be mounted together, with the front panel also being simplified: the stiffness provided by the two cross-members contributes to reducing twisting movements and thus enables reinforcing ribs to be reduced.

It may also be observed that the radiator arranged in accordance with the invention is particularly compact, being lower and wider than in the state of the art, in particular in the absence of support plates at the ends of the side rails. This can make it easier to direct air to its entire surface area, while also saving space in the front unit. This configuration makes it possible to match the width of the air inlet of the bumper skin to the width of the radiator. Under such circumstances, the entire section of the air inlet is effective, even at its side ends, which are often ignored and closed off in order to provide connection with lateral converging portions.

Since the cooling unit (fan, condenser, radiator) is more compact, it can be received in part below the impact beam, and since energy is absorbed by the absorbers in front of the beam, it is possible to reduce the overhang of the vehicle.

Finally, the radiator when arranged in accordance with the invention makes it easier to handle “hip” impacts, i.e. given its low height, it no longer constitutes a hard point that could injure the hip of a pedestrian of adult size, thereby leaving room to provide means for handling such an impact.

### PARTICULARLY ADVANTAGEOUS EMBODIMENTS

The assembly of the invention may include one or more of the following characteristics taken singly or in combination.

The top transverse element includes air flow means arranged to feed a top radiator provided above the radiator. Thus, it is possible to provide only one single bottom air inlet that is visible in the bumper skin, while nevertheless feeding air to a top radiator, e.g. a circuit for cooling an engine supercharger circuit.

The air flow means are ducts incorporated in the absorber and directed towards the top radiator.

The absorber comprises guide walls, constituting the walls of the guide compartment, these walls including specific air guide means, e.g. fins or deflectors.

The absorber also includes a bottom transverse element arranged at the height of the tibia of an adult pedestrian. Thus, the guide compartment defined by the absorber means is closed, thereby limiting leaks upstream from the heat exchangers.

The above-described arrangement also incorporates at least one fan, located in front of or behind the radiator, and substantially at the same height as the radiator. The width of the radiator, which is greater than the diameter of the central fan(s), makes it possible when the vehicle is running to leave the side zones of the radiator unoccupied, and when the vehicle is stationary with the fan in operation, the width of the radiator makes it possible to take advantage of the additional flow rate that can pass through said lateral zones in the opposite direction. The central fan(s) may be replaced by two lateral fans.

Downstream from the radiator, the arrangement further includes a wall for separating the air flow delivered by the fan from the air flow sucked in by the fan.

The invention also provides an absorber made of plastics material and suitable for an arrangement as described above.

### DESCRIPTION OF EXAMPLES

Example arrangements of the invention are illustrated with reference to the drawing that presents no limiting character, and in which:

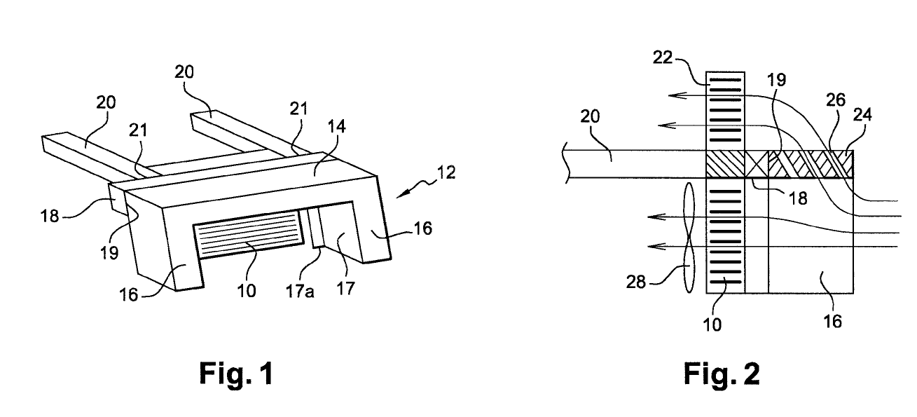

FIG. 1 is a diagram of an arrangement constituting a first embodiment of the invention; and

FIG. 2 is a longitudinal section of an arrangement constituting a second embodiment of the invention.

| Reference | | |
|---|---|---|
| in the | | Term used for the |
| FIGS. | General term | embodiment |
| 10 | Radiator | Bottom main radiator |
| 12 | Absorber | Upside-down U-shaped |
| | | plastics material absorber |
| | | made up of ribs located a |
| | | honeycomb |
| 14, 24 | Top transverse element | Top cross-member |
| 16 | Two vertical legs | |
| 17 | Absorber guide wall | Bottom walls of the legs |
| | | 16, bottom wall of the |
| | | cross-member 14 |
| 17a | Specific guide means | Deflector extending the |
| | | guide wall 17, directing |
| | | air towards the surface |
| | | area of the radiator |
| 18 | Impact beam | Rigid beam of thermoplastic |
| | | material or of metal- |
| | | plastic hybrid material |
| 19 | Front face of the beam | |
| 20 | Side rails | Main metal side rails of |
| | | the vehicle |
| 21 | Front ends of the side | |
| | rails 20 | |
| 22 | Top radiator | (Engine) supercharger air |
| | | radiator |
| 26 | Air flow means | Ducts formed by ribs in a |
| | | honeycomb arrangement and |
| | | directed to guide air |
| | | towards the top radiator 22 |
| 28 | Fan(s) | Fan(s) placed in front of |
| | | or behind the radiator 10 |

The beam 18 is mounted directly on the side rails 20. The radiator 10 is set back from the ends 21 so as to be protected by the beam 18 in the event of an impact.

The absorber 12 defines a compartment for guiding air towards the radiator 10. Guidance is improved with the help of deflectors 17a that can extend the absorber between the leg 16 and the radiator 10, thereby preventing air from escaping from the stream that is directed towards the radiator.

In the embodiment shown in FIG. 2, where a top radiator 22 is mounted above the bottom radiator 10, the absorber 12 also guides air to the top radiator. It is thus possible to have a single bottom air inlet in the bumper skin that is not very visible, and to avoid having a top air inlet.

It is possible to provide one or two fans 28 placed side by side, of diameter equal to the height of the radiator. It should be observed that this/these low fan(s) is/are protected during a Danner impact and make space available in the top portion of the front unit, thereby enabling the front overhang of the vehicle to be reduced. Thus, in the event of a Danner impact, more parts are protected and do not need to be replaced.

By means of the invention, the entire surface area of the radiator 10 that is to be cooled is positioned beneath the beam 18, so that air does not encounter any major obstacle.

1. An arrangement of a radiator (10), an absorber (12), and an impact beam (18) on a motor vehicle, the beam having a front face (19), and the arrangement being characterized in that the absorber comprises a top transverse element (14) and two vertical legs (16), in that the transverse element and the legs are arranged in such a manner as to guide air entering the vehicle from the front substantially towards the entire surface area of the radiator, and in that the top transverse element is mounted on the front face of the beam.

2. An arrangement according to claim 1, wherein the top transverse element includes air flow means (26) arranged to feed a top radiator (22) provided above the radiator.

3. An arrangement according to claim 2, wherein the air flow means are ducts (26) incorporated in the absorber and directed towards the top radiator.

4. An arrangement according to any one of claims 1 to 3, wherein the absorber includes guide walls (17), the guide walls including specific air guidance means (17a), e.g. a fin or a deflector.

5. An arrangement according to any one of claims 1 to 4, wherein the absorber further includes a bottom transverse element arranged at the height of the tibia of an adult pedestrian.

6. An arrangement according to any one of claims 1 to 5, together with at least one fan (28), the fan being of a diameter that is substantially equal to the height of the radiator.

7. An arrangement according to claim 6, comprising, downstream from the radiator, a wall for separating the discharged air stream from the sucked-in air stream.

8. An absorber (12) made of plastics material, suitable for an arrangement according to any one of claims 1 to 7.
